(19) United States
(12) Patent Application Publication
(10) Pub. No.: US 2011/0062391 A1
(43) Pub. Date: Mar. 17, 2011

(54) MANUFACTURING METHOD OF COMPOUND SEMICONDUCTOR MATERIAL, AND COMPOUND SEMICONDUCTOR MATERIAL USING THE SAME

(75) Inventors: Jae IL KIM, Gyeonggi-do (KR); Suk Jin Ham, Seoul (KR); Dong Hyun Cho, Gyeongsangnam-do (KR); In Hyung Lee, Seoul (KR)

(73) Assignee: SAMSUNG ELECTRO-MECHANICS CO., LTD.

(21) Appl. No.: 12/627,312

(22) Filed: Nov. 30, 2009

(30) Foreign Application Priority Data
Sep. 16, 2009 (KR) 10-2009-0087704

(51) Int. Cl. H01B 1/04

(52) U.S. Cl. 252/519.31

(57) ABSTRACT

The present invention provides a manufacturing method of group III-V compound semiconductor material including a step of making a metal oxide nano-particle of a group III metal element reductively react to a group-V-element-containing compound in order to manufacture compound semiconductor material comprised of two or more element compounds.

### CROSS-REFERENCE TO RELATED APPLICATIONS

This application claims the benefit of Korean Patent Application No. 10-2009-0087704 filed with the Korea Intellectual Property Office on Sep. 16, 2009, the disclosure of which is incorporated herein by reference.

### BACKGROUND OF THE INVENTION

1. Field of the Invention

The present invention relates to a manufacturing method of a compound semiconductor material and the compound semiconductor material manufactured by using the same; and, more particularly, to a manufacturing method of a group III-V compound semiconductor material including a step of a reduction reacting of a metal oxide nano-particle of a group III metal element with a compound which contains a group V element for manufacturing a compound semiconductor material composed of two or more element compounds.

2. Description of the Related Art

As the research of a fluorescent substance used in a Liquid Crystal Display (LCD) and an Organic Light Emitting Diode (OLED) or a light absorber used in a solar battery has been continuously conducted since the early 2000s, a semiconductor material applied to those things is also actively researched.

Particularly, efforts are steadily being made for variously changing morphology and characteristics of a semiconductor material and for improving whole efficiency by mass production and process improvement.

However, the conventionally researched manufacturing method of various compound semiconductors is mostly based on a high temperature pyrolysis reaction of each element precursor which constitutes the compound semiconductor.

For instance, the pyrolysis which is a basic synthesizing method of CdSe compound semiconductor is explained. As shown in a schematic diagram of FIG. 1, after injecting molecular Cd precursor material (dimethyl cadmium) and Se precursor material (tri octylphosphine selenide) into a surfactant solution, CdSe nano-particle formation is induced using the high temperature pyrolysis phenomenon of the precursor materials at a high reaction temperature.

FIG. 2 is a reaction schematic diagram showing a method of synthesizing InP compound semiconductor by using the high temperature pyrolysis. It can be shown that InP nano-particle is formed, like the CdSe synthesis, by injecting In precursor material (indium acetate) and P precursor material (tris(trimethylsilyl)phosophine, P(TMS)₃) into a solvent (1-octadecene) to which the surfactant (myristic acid) is added and performing a high temperature heat treatment.

However, according to the above-mentioned methods, it is a problem that a reaction process condition is complicated and mass production becomes difficult due to high activity and instability of a reaction material. For example, in the case of the P(TMS)₃ used as the P precursor material of the InP compound semiconductor which is a group III-V compound semiconductor, it is difficult to handle it at a high temperature due to the high chemical activity. Also, mass production is difficult because of an explosion risk at the time of mass injection.

Also, since the above-mentioned high activity reaction materials react even to oxygen, moisture and the like, a process of eliminating the oxygen and moisture is indispensably required and a one-pot reaction is difficult since a reaction condition is complicated. Moreover, a separation process of the reaction material after the reaction and impurities is also complicated, and thus whole process efficiency is decreased.

Also, according to the above-mentioned synthesis reaction using the high temperature pyrolysis, it is very difficult to adjust morphology, size and the like for diversifying the optical characteristics of the semiconductor material at the reaction process. Various researches for adjusting the morphology and size of the semiconductor material have been conducted for an application to various fields; however, since general usability is limited, practical use is difficult.

Therefore, the inventor of the present invention has been invented a method of manufacturing the compound semiconductor capable of not only increase of reaction efficiency but also mass production by simplifying the reaction process. Also, the inventor of the present invention has been invented the method of manufacturing the compound semiconductor capable of variously adjusting the morphology and size of the semiconductor material at a manufacturing step so that the compound semiconductor can be applied to various fields.

### SUMMARY OF THE INVENTION

An object of the present invention is to provide a manufacturing method of a compound semiconductor material capable of reaction efficiency improvement and mass production by simplifying a reaction process and the compound semiconductor material manufactured by using the manufacturing method.

Also, an object of the present invention is to provide a manufacturing method of a compound semiconductor material which is applicable to various fields by variously adjusting morphology and size of a semiconductor material at a manufacturing step and the compound semiconductor material manufactured by using the manufacturing method.

In accordance with one aspect of the present invention to achieve the object, there is provided a manufacturing method of group III-V compound semiconductor material including a step of making a metal oxide nano-particle of a group III metal element reductively react to a group-V-element-containing compound in order to manufacture compound semiconductor material comprised of two or more element compounds.

Herein, a step of adjusting morphology of the metal oxide nano-particle before the reduction reaction of the metal oxide nano-particle of the group III metal element and the group-V-element-containing compound can be additionally added, or a step of refining generated material for removing organic impurities from the generated material through a centrifugal separation process or an extracting process after the reduction reaction of the metal oxide nano-particle of the group III metal element and the group-V-element-containing compound can be additionally added.

Also, the metal oxide nano-particle of the group III metal element can be an indium oxide (In₂O₃) nano-particle, and the group-V-element-containing compound can be P(TMS)₃(tri(trimethylsilyl)phosphine), (DA)₃P(Tris(dimethylamino)phosphine, PH₃ or As(TMS)₃(tris(trimethylsilyl)arsine).

Also, the group-V-element-containing compound can be injected to the metal oxide nano-particle of the group III metal element at a room temperature, and the reduction reaction can be performed at a reaction temperature of 150° C. to 350° C. for 5 minutes to 48 hours.

In accordance with another aspect of the present invention to achieve the object, there is provided a group III-V compound semiconductor material manufactured by making a metal oxide nano-particle of a group III metal element reductively react to a group-V-element-containing compound.

Herein, the metal oxide nano-particle of the group III metal element can be an indium oxide (In₂O₃) nano-particle, and the group-V-element-containing compound can be P(TMS)₃(tri(trimethylsilyl)phosphine), (DA)₃P(Tris(dimethylamino)phosphine, PH₃ or As(TMS)₃(tris(trimethylsilyl)arsine), and indium phosphide (InP) or indium arsenide (InAs) can be finally manufactured through the reduction reaction.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic diagram showing a conventional synthesis process of CdSe using a high temperature pyrolysis;

FIG. 2 is a schematic diagram showing a conventional synthesis process of InP using the high temperature pyrolysis;

FIG. 3 is schematic diagram showing a manufacturing process of a metal oxide (In₂O₃) nano-particle without an external oxygen source supply; and

FIGS. 4 and 5 are images showing shapes before (FIG. 4) and after (FIG. 5) the metal oxide (In₂O₃) and a P source, i.e., P(TMS)₃, react.

### DETAILED DESCRIPTION OF THE PREFERABLE EMBODIMENTS

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of related art are omitted when it is deemed that they may unnecessarily obscure the essence of the invention.

Hereinafter, a method of manufacturing a compound semiconductor material and the compound semiconductor material manufactured by using the method in accordance with the present invention is described in detail with reference to the accompanying drawings.

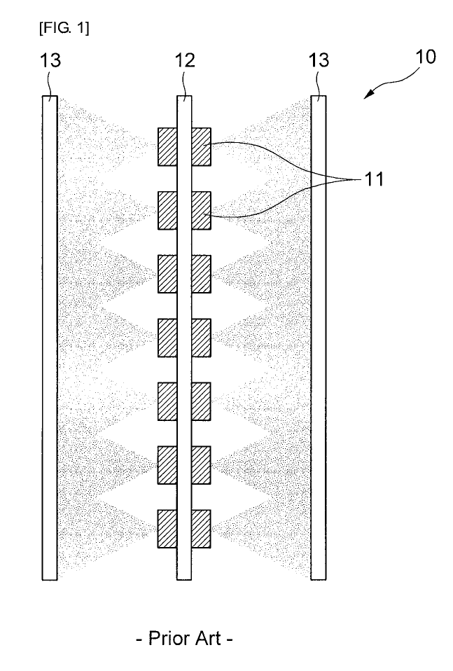

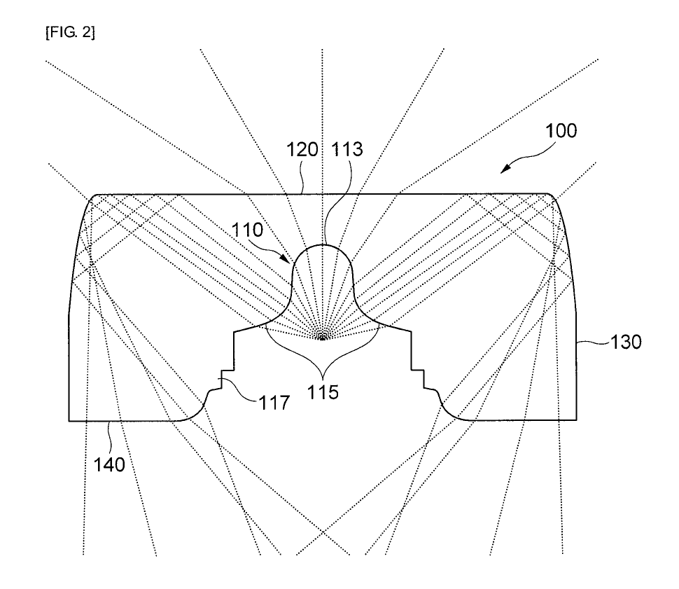

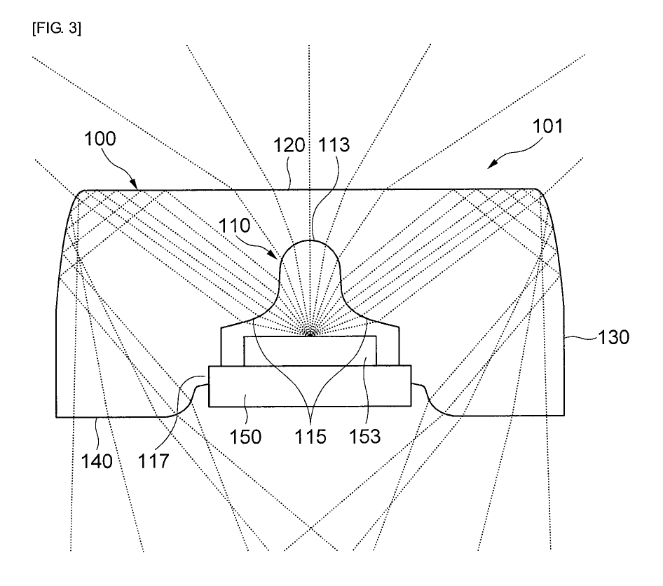

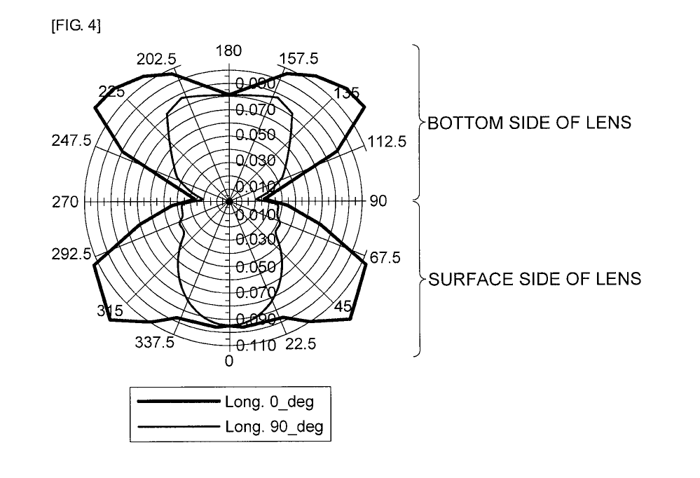

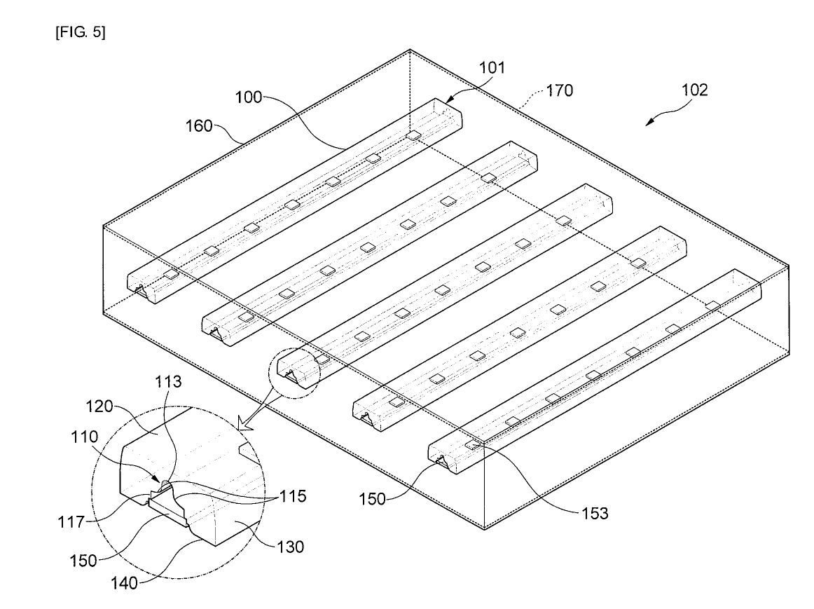

FIGS. 1 and 2 are schematic diagrams showing a conventional synthesis process of CdSe and InP using a high temperature pyrolysis. FIG. 3 is a schematic diagram showing a manufacturing process of a metal oxide (In₂O₃) nano-particle without an external oxygen source supply. FIGS. 4 and 5 are images respectively showing shapes before (FIG. 4) and after (FIG. 5) the metal oxide (In₂O₃) and a P source, i.e., P(TMS)₃, react.

The manufacturing method of the compound semiconductor in accordance with the present invention relates to a manufacturing method of a group III-V compound semiconductor comprised of two or more element compounds including a step of making the metal oxide nano-particle of a group III metal element react to a compound which contains a group V element.

According to the conventional basic manufacturing method of the group III-V compound semiconductor, a precursor which contains the group III metal element and a precursor which contains the group V element are made to pyrolytically react at a high temperature. For instance, in the case of manufacturing an indium phosphite (FIG. 2), an InP semiconductor material is gained by injecting a precursor molecular material which can provide P³⁻ by the pyrolysis such as P(TMS)₃ to a precursor molecular material which can provide In³⁺ by the pyrolysis such as an indium acetate and making them react as shown in Reaction Formula. 1 below.

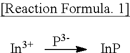

However, according to the above-mentioned methods, handling is difficult and a reaction process condition becomes complicated due to reaction characteristics of the high temperature pyrolysis and the high activity of the reaction material. Also, mass production is difficult because of an explosion risk at the time of mass injection.

However, according to the manufacturing method of the group III-V compound semiconductor of the present invention, by injecting a compound containing a group V element whose chemical activity is high to a metal oxide reaction material using the metal oxide nano-particle of a group III metal element as the reaction material and inducing a reduction reaction of them not the reaction through the high temperature pyrolysis, a final product, i.e., the group III-V compound semiconductor, is gained as shown in Reaction Formula. 2 below.

For instance, in the case of manufacturing an indium phosphide, an indium oxide is manufactured first and then a reaction material which has a high activity such as the P(TMS)₃ is contacted to the indium oxide so that the indium phosphide is finally produced by the reduction reaction of a phosphorous ingredient (P) of the P(TMS)₃ and O which exists on a surface of the metal oxide.

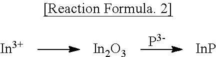

As shown in Reaction Formula. 2, if a material which can intensively react to oxygen such as the P(TMS)₃ contacts with the In₂O₃ nano-particle, the reduction reaction between the O ingredient which exists on the surface of the metal oxide and the phosphorous ingredient (P) of the P(TMS)₃ occurs.

That is, a material exchange occurs on the surface due to a surface instability of the nano-particle, and it is predictable that all the O ingredients which constitute the nano-particle react to the P considering the size characteristics of the nano-particle so that the metal phosphide is formed.

FIGS. 4 and 5 are images respectively showing shapes before (FIG. 4) and after (FIG. 5) the reduction reaction between the metal oxide (In₂O₃) and the P(TMS)₃. Herein, it can be ascertained that the P ingredient is newly added keeping a shape of the nano-particle by an EDX.

The metal oxide such as the In₂O₃ can be easily manufactured by simply performing a heat treatment on a metal material and also can be massively synthesized as much as desired as shown in FIG. 3. Also, according to the conventional high temperature pyrolysis, the mass production is difficult since it is dangerous to inject the group-V-element-containing compound whose chemical activity is high into a high temperature solution; however, the process of injecting the group-V-element-containing compound whose chemical activity is high into the metal oxide is sufficiently possible at a room temperature so that the mass production is sufficiently possible according to a production quantity of the metal oxide.

Meanwhile, according to the manufacturing method of the present invention, before making the metal oxide nano-particle of the group III metal element react to the group-V-element-containing compound, a step of adjusting morphology of the metal oxide nano-particle can be additionally included.

According to the conventional synthesis reaction using the high temperature pyrolysis, it is very difficult to adjust morphology, size and the like at the reaction process, and therefore it is difficult to apply the conventional synthesis reaction to a field which requires various optical characteristics. However, since the present invention is an indirect manufacturing method through the metal oxide, semiconductor materials of various figures can be manufactured through a shape control of the metal oxide. The variously-shaped semiconductor materials can be applied to various fields such a solar battery, a Liquid Crystal Display (LCD), an Organic Light Emitting Diode (OLED) and the like.

Various methods obtained from the research of adjusting method of the morphology of the metal oxide nano-particle by applying various reaction conditions are presently known. For instance, researches of forming variously-shaped metal oxide are actively conducted such as dot or flower shape (Narayanaswamy, A. et al., J. Am. Chem. Soc. 2006, 128, 10310), rod shape (Chen, C. et al., J. Phys. Chem. C 2007, 111, 18039), lotus root shape (Wang, C. et al., J. Phys. Chem. C 2007, 111, 13398), wire shape (Li, C. et al., Adv. Mater. 2003, 15, 143), cube shape (Chu, D. et al., Nanotechnology 2007, 18, 435608) and so on.

Also, according to the manufacturing method of the present invention, after making the metal oxide nano-particle of the group III metal element react to the group-V-element-containing compound, a step of refining a generated material for removing organic impurities from the generated material through a centrifugal separation process or an extracting process can be additionally included.

According to the conventional synthesis method using the high temperature pyrolysis, since the reaction materials chemically react even to oxygen, moisture and the like, a process of eliminating the oxygen and moisture is indispensably required, and a one-pot reaction is difficult since the reaction condition is complicated. Further, a separation process of the reaction material after the reaction and impurities is also complicated, and thus whole process efficiency is decreased.

However, according to the synthesis method of the present invention, since the impurities obtained after the reaction completion are just organic, the impurities can be removed by lowering temperature or putting an organic solvent such as acetone; and since a generated particle is large, the generated material can be collected by the centrifugal separation or the like. Also, in comparison with the method using the high temperature pyrolysis, the reaction condition is mild and the one-pot reaction combined with a temperature adjustment is possible so that the whole process efficiency can be improved.

Meanwhile, all of the commercially usable metal oxide nano-particle of a group III metal element can be used as the metal oxide nano-particle used for the manufacturing method of the present invention. Preferably, the indium oxide (In₂O₃) nano-particle can be used.

Also, all of the commercially usable group-V-element-containing compound can be used as the compound which reductively reacts to the metal oxide. Preferably, P(TMS)₃(tri(trimethylsilyl)phosphine), (DA)₃P(Tris(dimethylamino)phosphine, PH₃ or As(TMS)₃(tris(trimethylsilyl)arsine) can be used. At this time, through the reduction reaction, indium phosphide (InP) or indium arsenide (InAs) can be finally manufactured.

Meanwhile, since the group-V-element-containing compound can be injected to the metal oxide nano-particle of the group III metal element, safety can be secured. At the time of heating after the injection, the reduction reaction is immediately started; however, for the reduction reaction to be sufficiently done, it may take 5 minutes to 48 hours for the reduction reaction to be done at a temperature of 150° C. to 350° C.

Minutely explaining a manufacturing method of the indium oxide (In₂O₃) as one embodiment of the present invention, firstly P-stock solution is prepared by dissolving 0.2 mL of P(TMS)₃(tri(trimethylsilyl)phosphine) and 0.5 mL of octylamine (OctNH2) in 1 mL of TOP(Tri-n-octylphosphine).

Meanwhile, the indium oxide nano-particle is grown by heating mixture solution of 256 mg (1.0 mmol) of indium acetate(InAc₃), 0.1 mL of oleic acid (90% tech.) and 25 mL of ODE(1-octadecene) at a temperature of 180° C. for 30 minutes.

After cooling the formed indium oxide nano-particle solution to the room temperature, the prepared P-stock solution is injected, and after increasing the reaction temperature to 290° C. for growth of the indium oxide, this state is maintained for 30 minutes in order to finally gain the product of the indium oxide.

In this manner, according to the manufacturing method of the present invention, the metal oxide of the group III metal element as a reaction material is made to reductively react to the group-V-element-containing compound so that the reaction efficiency can be improved and the mass production is also possible by simplifying the reaction process in comparison with the conventional manufacturing method using the pyrolysis reaction.

Also, according to the manufacturing method of the present invention, by using the metal oxide as the reaction material, the morphology and size of the semiconductor material can be variously adjusted at the manufacturing step so that the compound semiconductor material which is applicable to various fields can be manufactured.

As described above, although the preferable embodiments of the present invention have been shown and described, it will be appreciated by those skilled in the art that substitutions, modifications and variations may be made in these embodiments without departing from the principles and spirit of the general inventive concept, the scope of which is defined in the appended claims and their equivalents.

What is claimed is:

1. A manufacturing method of group III-V compound semiconductor material comprising a step of making a metal oxide nano-particle of a group III metal element reductively react to a group-V-element-containing compound in order to manufacture compound semiconductor material comprised of two or more element compounds.

2. The manufacturing method of group III-V compound semiconductor material of claim 1 further comprising a step of adjusting morphology of the metal oxide nano-particle before the reduction reaction of the metal oxide nano-particle of the group III metal element and the group-V-element-containing compound.

3. The manufacturing method of group III-V compound semiconductor material of claim 1 further comprising a step of refining generated material for removing organic impurities from the generated material through a centrifugal separation process or an extracting process after the reduction reaction of the metal oxide nano-particle of the group III metal element and the group-V-element-containing compound.

4. The manufacturing method of group III-V compound semiconductor material of claim 1, wherein the metal oxide nano-particle of the group III metal element is an indium oxide (In₂O₃) nano-particle.

5. The manufacturing method of group III-V compound semiconductor material of claim 1, wherein the group-V-element-containing compound is P(TMS)₃(tri(trimethylsilyl)phosphine), (DA)₃P(Tris(dimethylamino)phosphine, PH₃ or As(TMS)₃(tris(trimethylsilyl)arsine).

6. The manufacturing method of group III-V compound semiconductor material of claim 1, wherein the group-V-element-containing compound is injected to the metal oxide nano-particle of the group III metal element at a room temperature.

7. The manufacturing method of group III-V compound semiconductor material of claim 1, wherein the reduction reaction is performed at a reaction temperature of 150° C. to 350° C. for 5 minutes to 48 hours.

8. A group III-V compound semiconductor material manufactured by making a metal oxide nano-particle of a group III metal element reductively react to a group-V-element-containing compound, for providing compound semiconductor material comprised of two or more element compounds.

9. The group III-V compound semiconductor material of claim 8, wherein the metal oxide nano-particle of the group III metal element is an indium oxide (In₂O₃) nano-particle.

10. The group III-V compound semiconductor material of claim 8, wherein the group-V-element-containing compound is P(TMS)₃(tri(trimethylsilyl)phosphine), (DA)₃P(Tris(dimethylamino)phosphine, PH₃ or As(TMS)₃(tris(trimethylsilyl)arsine).

11. The group III-V compound semiconductor material of claim 8, wherein semiconductor material manufactured through the reduction reaction is indium phosphide (InP) or indium arsenide (InAs).
